(19) United States
(12) Patent Application Publication
(10) Pub. No.: US 2023/0351314 A1
(43) Pub. Date: Nov. 2, 2023

(54) DISTRIBUTION ANALYSIS APPARATUS, DISTRIBUTION HUB SETTING-UP SUPPORT APPARATUS, AND METHOD

(71) Applicant: NEC Corporation, Minato-ku, Tokyo (JP)

(72) Inventor: Michihiko Yusa, Tokyo (JP)

(73) Assignee: NEC Corporation, Minato-ku, Tokyo (JP)

(21) Appl. No.: 18/020,211

(22) PCT Filed: Aug. 24, 2020
(86) PCT No.: PCT/JP2020/031890

§ 371 Date: Feb. 7, 2023

(51) Int. Cl. G06Q 10/0834

(52) U.S. Cl. CPC G06Q 10/08345

(57) ABSTRACT

In a distribution analysis apparatus, a loading information collecting unit collects loading information of a vehicle configured to deliver packages. A loading rate summarizing unit summarizes a package loading rate for each vehicle for each predetermined summarizing unit based on the loading information collected within a predetermined period. A display unit displays the summarized package loading rate on a map.

### TECHNICAL FIELD

The present disclosure relates to a distribution analysis apparatus, a distribution hub setting-up support apparatus, a method, and a computer readable medium.

### BACKGROUND ART

As related art, Patent Literature 1 discloses a transportation management system. The transportation management system disclosed in Patent Literature 1 stores operation record data including a loading rate for each delivery vehicle based on a delivery history in which history data is accumulated on a daily basis. Further, the transportation management system stores, for each delivery vehicle, transaction records for respective senders based on the delivery history. In the transportation management system, an operation prediction unit predicts a loading rate of each delivery vehicle in the future based on the operation record data. A delivery-vehicle matching unit performs a delivery-vehicle matching process by using the transaction records for respective senders and the loading rates predicted by the operation prediction unit (predicted loading rates).

In the delivery-vehicle matching process, the delivery-vehicle matching unit extracts a first candidate vehicle that has a transaction record with a sender of a delivery request based on the transaction records for respective senders. The delivery-vehicle matching unit extracts, by using the predicted loading rate of the first candidate vehicle, a vehicle of which the volume of the requested packages and the like is equal to or smaller than the predicted loading rate. When no vehicle of which the volume of the requested packages and the like is equal to or smaller than the predicted loading rate is extracted, the delivery-vehicle matching unit extracts a second candidate vehicle that has no transaction record with the sender. The delivery-vehicle matching unit extracts, by using a free loading rate, i.e., a value obtained by subtracting the predicted loading rate from the loading capacity of the second candidate vehicle (i.e., the predicted available loading rate), a vehicle of which the free loading rate is equal to or smaller than the volume of the requested packages and the like.

Further, in the transportation management system, an operation information collection unit collects, for each delivery vehicle, operation status data of the delivery vehicle from a delivery-staff terminal. The operation information collection unit accumulates, as the operation status data, information such as a date, a time, and an available capacity ratio on a cargo bed transmitted from the delivery-staff terminal. Based on the operation status data, an operation information providing unit provides, to a business-operator terminal, a map including a current position(s) and/or a movement path(s) of one or a plurality of delivery vehicles. In this case, the operation information providing unit can display, in the business-operator terminal, a symbol mark representing each delivery vehicle while incorporating a loading rate into the symbol mark. By displaying the symbol marks representing a plurality of delivery vehicles which are under the jurisdiction of the business operator managing the operation on one map, the business owner can keep track of the operation statuses of the plurality of delivery vehicles.

### CITATION LIST

### Patent Literature

Patent Literature 1: Japanese Unexamined Patent Application Publication No. 2017-165510

### SUMMARY OF INVENTION

### Technical Problem

The transportation management system disclosed in Patent Literature 1 can make it possible to perform transportation management under which vehicles can be preferentially secured for specific senders and delivery operations for other senders can be efficiently performed. Further, in Patent Literature 1, the movement path and the loading rate of each delivery vehicle are displayed on the map, so that the business operator managing the operation can keep track of the operation statuses of the delivery vehicles. However, the purpose of Patent Literature 1 is to perform efficient operations of individual delivery vehicles. Therefore, the transportation management system disclosed in Patent Literature 1 does not always make it possible to construct an efficient distribution system in the sense of the entire distribution.

In view of the above-described circumstances, an object of the present disclosure is to provide, in an aspect, a distribution analysis apparatus, a method, and a computer readable medium capable of providing, to a user, information by which the user can construct an efficient distribution system.

Further, in another aspect, another object of the present disclosure is to provide a distribution hub setting-up support apparatus, a method, and a computer readable medium that can be used to construct an efficient distribution system. Solution to Problem

To achieve the above-described object, in an aspect, the present disclosure provides a distribution analysis apparatus. The distribution analysis apparatus includes: loading information collecting means for collecting loading information of a vehicle configured to deliver packages; loading rate summarizing means for summarizing a package loading rate for each vehicle for each predetermined summarizing unit based on the loading information collected within a predetermined period; and display means for displaying the summarized package loading rate on a map.

Further, the present disclosure provides a distribution analysis method. The distribution analysis method includes: collecting loading information of a vehicle configured to deliver packages; summarizing a package loading rate for each vehicle for each predetermined summarizing unit based on the loading information collected within a predetermined period; and displaying the summarized package loading rate on a map.

The present disclosure provides a computer readable medium. A computer readable medium stores a program for causing a computer to perform: collecting loading information of a vehicle configured to deliver packages; summarizing a package loading rate for each vehicle for each predetermined summarizing unit based on the loading information collected within a predetermined period; and displaying the summarized package loading rate on a map.

In another aspect, the present disclosure provides a distribution hub setting-up support apparatus. The distribution hub setting-up support apparatus includes: candidate site determination means for determining at least one candidate site for a distribution hub; simulation means for performing a simulation by using loading information of a vehicle configured to deliver packages, and thereby simulating deliveries of the packages under an assumption that the distribution hub has been set up at the candidate site; and assessment means for assessing, by using a result of the simulation performed by the simulation means, a cost of the deliveries under the assumption that the distribution hub has been set up at the candidate site.

The present disclosure provides a distribution hub setting-up support method. The distribution hub setting-up support method includes: determining at least one candidate site for a distribution hub; performing a simulation by using loading information of a vehicle configured to deliver packages, and thereby simulating deliveries of the packages under an assumption that the distribution hub has been set up at the candidate site; and assessing, by using a result of the simulation, a cost of the deliveries under the assumption that the distribution hub has been set up at the candidate site.

The present disclosure provides a computer readable medium. The computer readable medium stores a program for causing a computer to perform: determining at least one candidate site for a distribution hub; performing a simulation by using loading information of a vehicle configured to deliver packages, and thereby simulating deliveries of the packages under an assumption that the distribution hub has been set up at the candidate site; and assessing, by using a result of the simulation, a cost of the deliveries under the assumption that the distribution hub has been set up at the candidate site.

### ADVANTAGEOUS EFFECTS OF INVENTION

The distribution analysis apparatus, the method, and the computer readable medium according to the present disclosure can provide, to a user, information by which the user can construct an efficient distribution system.

Further, the distribution hub setting-up support apparatus, the method, and the computer readable medium according to the present disclosure can be used to construct an efficient distribution system.

### BRIEF DESCRIPTION OF DRAWINGS

FIG. 1 is a block diagram showing a schematic configuration of a distribution analysis apparatus according to the present disclosure;

FIG. 2 is a block diagram showing a schematic configuration of a distribution hub setting-up support apparatus according to the present disclosure;

FIG. 3 is a block diagram showing a distribution analysis apparatus according to an example embodiment in accordance with the present disclosure;

FIG. 4 is a route diagram showing routes along which vehicle travels;

FIG. 5 shows an example of an image displayed by a display unit;

FIG. 6 schematically shows deliveries under an assumption that a distribution hub has been set up;

FIG. 7 is a flowchart showing an operating procedure when loading rates are displayed on a map;

FIG. 8 is a flowchart showing an operating procedure performed by a distribution hub setting-up support; and

FIG. 9 is a block diagram showing an example of a configuration of a computer apparatus.

### EXAMPLE EMBODIMENT

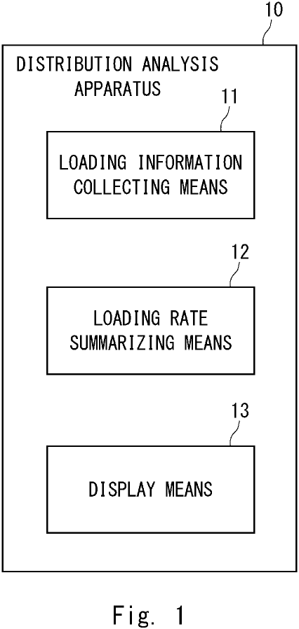

An outline of the present disclosure will be described prior to the description of an example embodiment according to the present invention. In an aspect, the present disclosure provides a distribution analysis apparatus. FIG. 1 shows a schematic configuration of a distribution analysis apparatus according to the present disclosure. A distribution analysis apparatus 10 includes loading information collecting means 11, loading rate summarizing means 12, and display means 13. The loading information collecting means 11 collects loading information of vehicles that deliver packages and the like. The loading rate summarizing means 12 summarizes (e.g., calculates) a package loading rate for each vehicle for each predetermined summarizing unit based on loading information collected within a predetermined period. The display means 13 displays the summarized package loading rate on a map.

The distribution analysis apparatus 10 according to the present disclosure displays the information about the package loading rate collected in the predetermined period on the map. The package loading rate has relevance to the efficiency of the distribution, and it can be said that the higher the package loading rate is in a given place, the more efficiently deliveries are performed in that place. A user of the distribution analysis apparatus 10 can find, by referring to the package loading rates shown on the map, places where deliveries are efficiently performed and places where deliveries are not efficiently performed. Using such knowledge, the user can conceive measures to improve the delivery infrastructure, such as where the user should set up a distribution hub(s) (a distribution center(s)) in order to improve the efficiency of deliveries. As described above, the distribution analysis apparatus 10 can provide, to a user, information by which the user can construct an efficient distribution system.

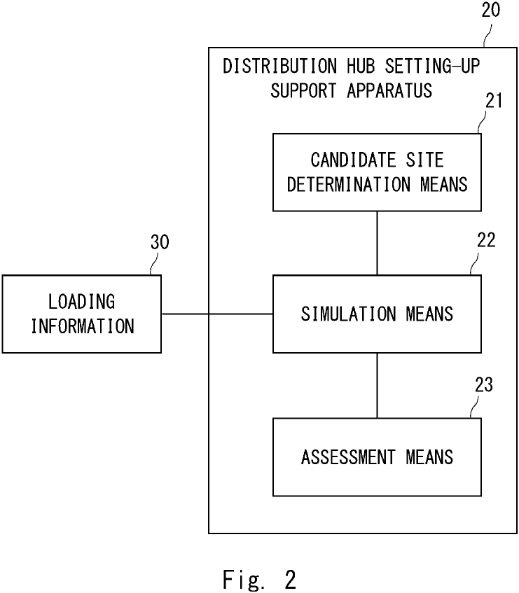

In another aspect, the present disclosure discloses a distribution hub setting-up support apparatus. FIG. 2 shows a schematic configuration of a distribution hub setting-up support apparatus according to the present disclosure. A distribution hub setting-up support apparatus 20 includes a candidate site determination means 21, simulation means 22, and assessment means 23. The candidate site determination means 21 determines at least one candidate site for a distribution hub. The simulation means 22 performs a simulation by using loading information 30 of vehicles that deliver packages and the like, and thereby simulates deliveries of the packages and the like under the assumption that the distribution hub(s) is set up at the candidate site(s). The assessment means 23 assesses, by using the result of the simulation performed by the simulation means 22, the cost of the deliveries under the assumption that the distribution hub(s) is set up at the candidate site(s).

The user of the distribution analysis apparatus 10 can narrow down, to some extent, the areas or the like where the distribution needs to be improved by using the above-described distribution analysis apparatus 10. However, selecting a site where a distribution hub is set up requires experience and intuition, so there is a problem that a distribution hub may not always be set up in an optimal site. In the distribution hub setting-up support apparatus 20 according to the present disclosure, the simulation means 22 simulates deliveries of packages and the like under the assumption that a distribution hub has been set up at the candidate site, and the assessment means 23 assess the cost of deliveries by using the result of the simulation. The user of the distribution hub setting-up support apparatus 20 can determine, by referring to the result of the assessment made by the assessment means 23, whether or not deliveries will be able to be efficiently performed after the distribution hub is set up at the candidate site, which is determined by the candidate site determination means 21. As described above, the distribution hub setting-up support apparatus 20 can be used to construct an efficient distribution system.

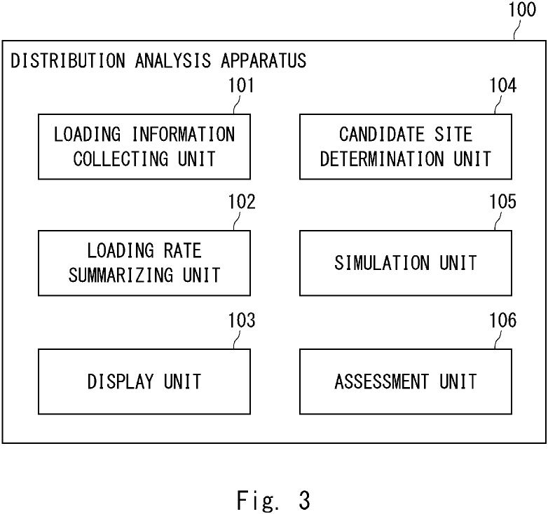

An example embodiment according to the present disclosure will be described hereinafter in detail. FIG. 3 shows a distribution analysis apparatus according to an example embodiment in accordance with the present disclosure. A distribution analysis apparatus 100 includes a loading information collecting unit 101, a loading rate summarizing unit 102, a display unit 103, a candidate site determination unit 104, a simulation unit 105, and an assessment unit 106. The distribution analysis apparatus 100 corresponds to the distribution analysis apparatus 10 shown in FIG. 1.

The loading information collecting unit 101 collects loading information of vehicles that deliver packages and the like. Each of the vehicles may be, for example, a vehicle such as a truck that travels on a road, or may be a railway vehicle. The loading information includes, for example, at least one delivery point and package information at each delivery point. The package information at each delivery point includes, for example, the type (the category) of a package or the like to be delivered to the delivery point, and the weight of the package or the like. The loading information may further include the maximum loading capacity of the vehicle, a delivery date and time, a start time, an end time, and a start point. The loading information collecting unit 101 acquires the loading information from, for example, a server of a transportation company that manages delivery slips. The loading information collecting unit 101 may acquire, as at least a part of the loading information, information obtained from a sensor(s), such as position information sensor and a weight sensor, provided in the vehicle. The loading information collecting unit 101 corresponds to the loading information collecting means 11 shown in FIG. 1.

The loading rate summarizing unit 102 summarizes (e.g., calculates) a package loading rate for each vehicle for each predetermined summarizing unit based on loading information collected within a predetermined period. For example, the user can specify a certain period such as six months or one year as the predetermined period. The package loading rate is expressed as a ratio of the amount (e.g., the weight) of packages and like loaded (i.e., carried) in the vehicle to the maximum loading capacity of the vehicle. For example, the loading rate summarizing unit 102 summarizes a package loading rate for each of the routes, such as Route 1 and Route 246, on which the vehicle travels. The loading rate summarizing unit 102 may summarize a package loading rate for each of the directions of the route, such as for each of up and down directions or each or clockwise and counterclockwise directions. The loading rate summarizing unit 102 may summarize a package loading rate for each unit distance, such as for every one kilometer or for every five kilometers. For example, the loading rate summarizing unit 102 may summarize a package loading rate for each type (each category) of packages and the like, such as for frozen foods and for electronic components. The user may designate all the categories as categories for each of which the package loading rate should be summarized, or only a specific category(ies) as the category(ies) for which the package loading rate should be summarized. The loading rate summarizing unit 102 corresponds to the loading rate summarizing means 12 shown in FIG. 1.

The display unit 103 displays the package loading rates summarized by loading rate summarizing unit 102 on the map. The display unit 103 displays the summarized loading rates, for example, on a geographic information system (GIS) map or a map schematically showing travelling routes of vehicles. The display unit 103 may classify the package loading rates into a plurality of levels. For example, in the case where, for a certain route, loading rates are summarized for each unit distance, the display unit 103 may display, for each unit distance (each section), the loading rates in different colors according to their levels. The display unit 103 displays the package loading rates, for example, on a display device such as a liquid-crystal display device. The display unit 103 may display the package loading rates on an apparatus, such as a smartphone or a tablet-type computer, possessed (or carried) by the user. The display unit 103 corresponds to the display means 13 shown in FIG. 1.

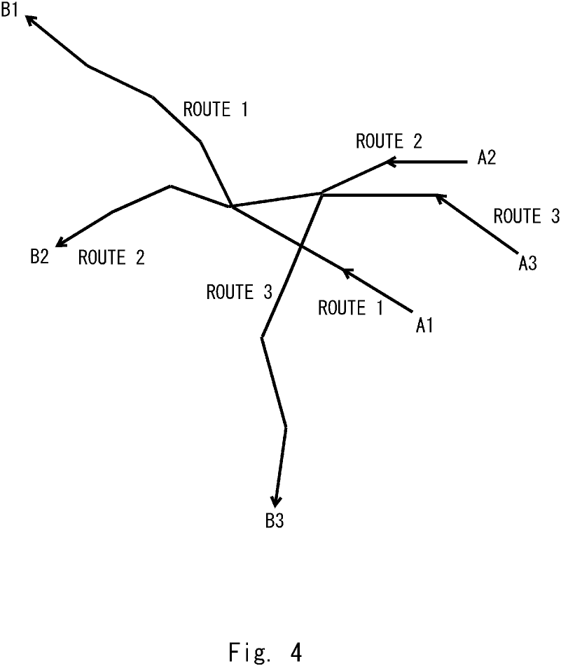

FIG. 4 shows a route diagram showing routes on which vehicles travel. FIG. 4 shows a route 1 including points A1 and B1, a route 2 including points A2 and B2, and a route 3 including points A3 and B3. For example, the loading rate summarizing unit 102 summarizes (e.g., calculates), for each unit distance, the loading rates of vehicles traveling on the route 1 in a direction from the point A1 toward the point B1. Further, the loading rate summarizing unit 102 summarizes (e.g., calculates), for each unit distance, the loading rates of vehicles traveling on the route 2 from the point A2 toward the point B2, and the loading rates of vehicles traveling on the route 3 from the point A3 toward the point B3. The loading rate summarizing unit 102 also summarizes the loading rates of vehicles traveling, on each of the routes, in the direction opposite to the above-described direction.

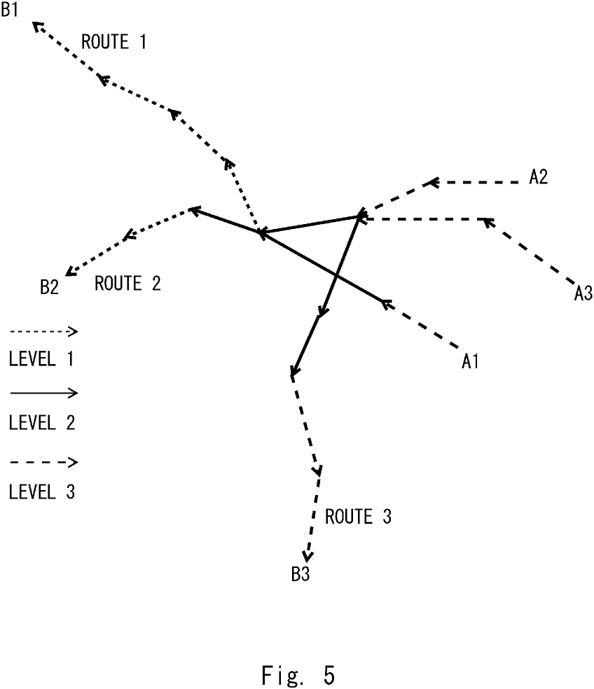

FIG. 5 shows an example of an image displayed by the display unit 103. For example, the display unit 103 classifies the package loading rates into three levels, i.e., a level 1 to level 3. For example, the display unit 103 classifies a package loading rate lower than 30% into the level 1, a package loading rate no lower than 30% and lower than 60% into the level 2, and a package loading rate equal to or higher than 60% into the level 3. The user may be able to set the number of levels and the package loading rate boundary values between the levels.

In FIG. 5, the levels of the package loading rates are displayed on the map schematically showing shapes of routes. In FIG. 5, the level 1 is represented by dotted lines, and the level 2 are represented by solid lines. Further, the level 3 are represented by dashed lines. The user can find, for each section of each route, whether the loading rate is high or low by referring to the map shown in FIG. 5. By recognizing where the loading rate is low and where the loading rate is high, the user can make a plan for improving the distribution infrastructure in order to achieve efficient deliveries.

Referring to FIG. 3 again, the candidate site determination unit 104 determines at least one candidate site for a distribution hub. For example, the candidate site determination unit 104 determines (i.e., selects) a candidate site for a distribution hub from among a predetermined number of candidate sites. The plurality of candidate sites include sites that face (i.e., are adjacent to) wide roads such as national roads. The plurality of candidate sites may be determined, for example, by the user based on information about the package loading rates that the display unit 103 displays on the map. It is assumed that, for example, the distribution hub to be set up will be commonly used (i.e., shared) by a plurality of transportation business operators. The distribution hub is operated, for example, by the national government or a local government.

The distribution hub may include a plurality of different-scale distribution hubs of which the amounts of packages and the like that can be temporarily stored therein are different from each other. The scales of distribution hubs include, for example, “large”, “medium” and “small”. It is assumed that a “large-scale” distribution hub can temporarily store 10,000 tons of packages and the like. It is assumed that a “medium-scale” distribution hub can temporarily store 1,000 tons of packages and the like, and a “small-scale” distribution hub can temporarily store 500 tons of packages and the like. A setting-up budget is determined in advance for each of the plurality of different-scale distribution hubs. It is assumed that, for example, the setting-up budget for a “large-scale” distribution hub is 2,000 million yen; the setting-up budget for a “medium-scale” distribution hub is 1,000 million yen; and the setting-up budget for a “small-scale” distribution hub is 500 million yen.

The candidate site determination unit 104 determines (i.e., selects) a candidate site from a plurality of candidate sites under predetermined constraint conditions, and determines the scale of the distribution hub. The constraint conditions include, for example, an upper limit for the number of distribution hubs to be set up and an upper limit for the setting-up budget for the distribution hubs. The candidate site determination unit 104 determines a combination of the number of distribution hubs and the scales of the distribution hubs so that the number of distribution hubs is equal to or less than the upper limit therefor and the sum total of the setting-up budgets for the distribution hubs is equal to or lower than the upper limit therefor.

For example, it is assumed that the upper limit for the number of distribution hubs is 20 and the upper limit for the setting-up budget is 10 billion yen. In that case, the candidate site determination unit 104 determines, as a candidate site(s) for a distribution hub(s), a combination of the number of distribution hubs and the scales thereof that satisfies the constraint conditions. For example, the candidate site determination unit 104 successively determines, as the candidate sites, all combinations that satisfy the constraint conditions. For example, the candidate site determination unit 104 determines a candidate site at which one “small-scale” distribution hub will be set up. Further, the candidate site determination unit 104 determines two candidate sites at which two “large-scale” distribution hubs will be set up respectively, two candidate sites at which two “medium-scale” distribution hubs will be set up respectively, and eight candidate sites at which eight “small-scale” distribution hubs will be set up respectively. That is, the candidate site determination unit 104 determines 12 candidate sites in total. Further, the candidate site determination unit 104 determines 20 candidate sites at which 20 “small-scale” distribution hubs will be set up respectively. The candidate site determination unit 104 corresponds to the candidate site determination means 21 shown in FIG. 2.

The simulation unit 105 performs a simulation by using the loading information collected by the loading information collecting unit 101, and thereby simulates deliveries of packages and the like under the assumption that the distribution hub(s) has been set up at the candidate site(s) determined by the candidate site determination unit 104. In the simulation, the simulation unit 105 determines whether or not the candidate site for distribution hub is included in the delivery route of the vehicle. When the simulation unit 105 determines that the candidate site for the distribution hub is included in the delivery route, it assumes that the vehicles will temporarily store the packages or the like to be delivered in the distribution hub. In the case where the packages and the like are temporarily stored, if the amount of packages and the like to be temporarily stored in the distribution hub exceeds the amount of packages and the like that can be temporarily stored therein, which changes according to the scale thereof, the packages and the like are not temporarily stored therein.

In the simulation, it is assumed that deliveries of packages and the like from the distribution hub to the next delivery points are performed from the distribution hub. The simulation unit 105 performs the simulation under the assumption that packages and the like, which have been temporarily stored in the distribution hub, are loaded in vehicles and then the vehicles deliver them from the distribution hub to the next delivery points. It is assumed that deliveries from the distribution hub to the delivery points are performed as being scheduled. It is assumed that, for example, when a delivery deadline for a given package or the like is determined, this package or the like is delivered from the distribution hub to the delivery point by the delivery deadline. The simulation unit 105 corresponds to the simulation means 22 shown in FIG. 2.

The assessment unit 106 assess, by using the result of the simulation performed by the simulation unit 105, the cost for the deliveries that is estimated under the assumption that the distribution hub has been set up at the candidate site. For example, the assessment unit 106 calculates, as an index indicating the cost for the deliveries, at least one of the sum total of traveling distances of all the vehicles, the sum total of values that are obtained by multiplexing traveling distances of all the vehicles by the amounts of packages and the like delivered by the respective vehicles, and the sum total of the setting-up budgets for the distribution hub. Regarding each of the sum total of traveling distances of all the vehicles, the sum total of values that are obtained by multiplexing traveling distances of all the vehicles by the amounts of packages and the like delivered by the respective vehicles, and the sum total of the setting-up budgets for the distribution hub, the smaller the value is, the higher assessment the value indicates. As an alternative to the above-described calculation, the assessment unit 106 may calculate such an assessment index that the larger the value is, the higher assessment the value indicates. The assessment unit 106 corresponds to the assessment means 23 shown in FIG. 2.

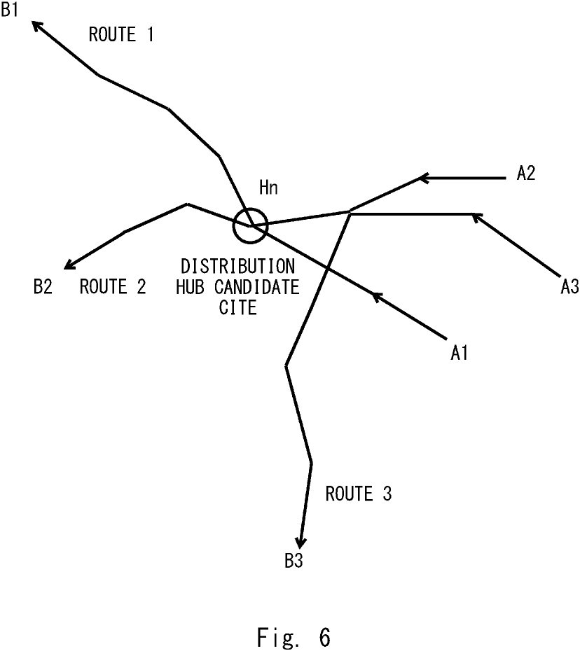

FIG. 6 schematically shows deliveries that are performed under the assumption that a distribution hub has been set up. FIG. 6 shows an example in which a distribution hub is set up at a candidate site Hn that is included in both the routes 1 and 2. In the simulation, the packages and the like of the vehicle traveling on the route 1 are delivered from the point A1 to the distribution hub candidate site Hn according to the record in the past, i.e., according to the information included in the loading information. Further, the packages and the like of the vehicle traveling on the route 2 are delivered from the point A2 to the distribution hub candidate site Hn according to the record in the past. In the simulation, the packages and the like delivered to the respective delivery points included in the route from the distribution hub candidate site Hn to the point B1 are delivered from the distribution hub. Further, the packages and the like delivered to the respective delivery points included in the route from the distribution hub candidate site Hn to the point B2 are delivered from the distribution hub. Regarding the route 3, since the distribution hub candidate site Hn is not included in the route, the packages and the like are delivered according to the record in the past.

For example, the route 1 will be examined hereinafter. It is assumed that the distance from the point A1 to the point B1 is 100 km, and a total of 500 vehicles were used to deliver packages and the like in a predetermined period. In that case, the total traveling distance of all the vehicles is expressed as 100 km × 500 vehicles = 50,000 km. When the distribution hub is set up at the candidate site Hn, a total number of vehicles that are used to deliver packages and the like from the point A1 to the distribution hub candidate site Hn is 500, which is unchanged from the number of vehicles that are used before the distribution hub is set up. Meanwhile, the number of vehicles necessary to deliver packages and the like from the distribution hub candidate site Hn to the point B1 may be reduced from 500 because packages and the like can be collected at the distribution hub.

Here, as a result of the simulation, it is assumed that a total number of vehicles that deliver packages and the like from the distribution hub candidate site Hn to the point B1 in the predetermined period is 150. Under the assumption that the distance from the point A1 to the distribution hub candidate site Hn is 50 km, the total traveling distance traveled by the vehicles on the route 1 is expressed as 50 km × 500 vehicles + 50 km × 150 vehicles = 25,000 km + 7,500 km = 32,500 km. In this case, when the distribution hub is set up at the distribution hub candidate site Hn, the total traveling distance for the route 1 can be reduced from 50,000 km to 32,500 km. When the total traveling distance is reduced by setting up a distribution hub, fuel costs and carbon dioxide emissions can be reduced, and the working hours of the drivers of the vehicles can be reduced. The assessment unit 106 performs the above-described calculation for each of the other routes, and thereby calculates the total traveling distance for the route under the assumption that the distribution hub has been set up.

The candidate site determination unit 104 determines a candidate site for a distribution hub for each of a plurality of patterns in which combinations of the number of hubs and the scales thereof differ from one another. For each of the patterns, the simulation unit 105 simulates, by using collected loading information, deliveries of packages and the like under the assumption that the distribution hub has been set up at the candidate site. For each of the patterns, the assessment unit 106 calculates an assessment index such as a total traveling distance based on the result of the simulation. For example, the assessment unit 106 may present (i.e., show), to the user, a candidate site for a distribution hub of the pattern of which the value of the assessment index is the lowest, and the scale of the distribution hub. The user of the distribution analysis apparatus 100 can determine the place at which a distribution hub will be set up and the scale thereof based on the assessment index calculated by the assessment unit 106.

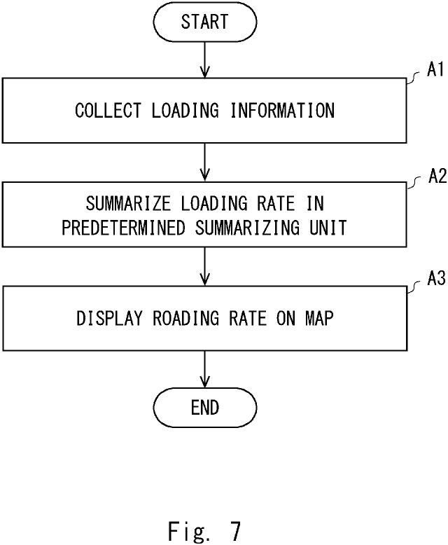

Next, an operating procedure will be described. FIG. 7 shows an operating procedure (a distribution analysis method) performed by the distribution analysis apparatus 100 when loading rates are displayed on a map. The loading information collecting unit 101 collects loading information of vehicles that deliver packages and the like (Step A1). The loading rate summarizing unit 102 summarizes (i.e., calculates) a package loading rate for each vehicle for each predetermined summarizing unit based on loading information collected within a predetermined period (Step A2). In the step A2, for example, the loading rate summarizing unit 102 summarizes a loading rate for each route, for each unit distance, and for each direction in the route.

The display unit 103 displays the package loading rates summarized by the loading rate summarizing unit 102 on the map (Step A3). In the step A3, the display unit 103 classifies, for example, the package loading rates into a plurality of levels and displays the levels of the package loading rates on a GIS map or a map schematically showing travelling routes of vehicles. For example, the display unit 103 displays, for each route and for each unit distance, the levels of package loading rates in different colors according to the levels. The user of the distribution analysis apparatus 100 can make a plan for improving the distribution system by referring to the displayed distribution of package loading rates and the like.

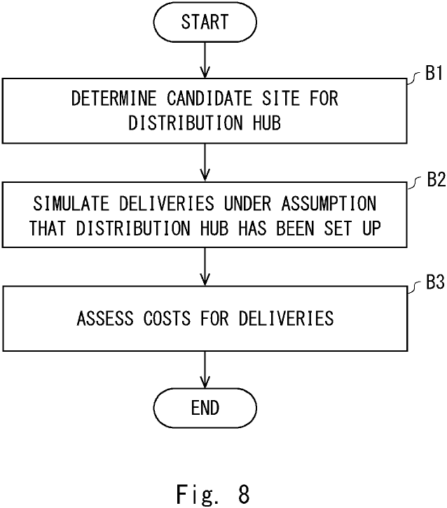

FIG. 8 shows an operating procedure for supporting the set-up of a distribution hub (a distribution hub setting-up support method) performed by the distribution analysis apparatus 100. The candidate site determination unit 104 determines at least one candidate site for a distribution hub (Step B1). In the step B1, for example, the candidate site determination unit 104 determines, as a candidate site for a distribution hub, a combination of the number of distribution hubs and the scales thereof under the conditions that the number of distribution hubs to be set up is equal to or less than the upper limit therefor and the setting-up budget is equal to or lower than the upper limit therefor.

The simulation unit 105 performs a simulation by using loading information collected by the loading information collecting unit 101, and thereby simulates the deliveries of packages and the like under the assumption that the distribution hub has been set up at the candidate site determined in the step B1 (Step B2). In the step B2, when the simulation unit 105 determines that the candidate site for the distribution hub is included in the delivery route, it assumes that the vehicles will temporarily store the packages or the like to be delivered in the distribution hub. In the simulation, it is assumed that the deliveries of packages and the like are performed from the distribution hub.

The assessment unit 106 assess, by using the result of the simulations performed by the simulation unit 105, the cost for the deliveries that is estimated under the assumption that the distribution hub has been set up at the candidate site (Step B3). In the step B3, the assessment unit 106 calculates, for example, the sum total of traveling distances of all the vehicles as an index indicating the cost for the deliveries. The candidate site determination unit 104 can determine the candidate site for the distribution hub in each of a plurality of patterns in which combinations of the number of hubs and the scales thereof differ from one another, and the assessment unit 106 can calculate the total traveling distance and the like for each of the patterns. In that case, the user can compare the total traveling distances in the patterns with one another, and thereby find out the place where the distribution hub is set up and the scale thereof with which place and scale the efficiency of the deliveries are maximized.

In this example embodiment, the display unit 103 displays information about package loading rates on the map. The user can find the area where the efficiency of deliveries is poor by referring to the information about package loading rates displayed on the map. By recognizing which area(s) has poor delivery efficiency, the user can conceive measures to improve the delivery infrastructure, such as where the user should set up a distribution hub(s) (a distribution center(s)) in order to improve the efficiency of deliveries. As described above, this example embodiment can provide, to a user, information by which the user can construct an efficient distribution system.

Further, in this example embodiment, the simulation unit 105 simulates the deliveries of packages and the like under the assumption that a distribution hub has been set up. When the distribution hub candidate site is included in the route, the simulation unit 105 performs a simulation under the assumption that packages and the like are temporarily stored in the distribution hub and the temporarily-stored packages and the like are delivered from the distribution hub. When a distribution hub is set up, packages and the like are collected there, so in some cases, the number of vehicles used for the deliveries from the distribution hub to the next delivery points can be reduced. The assessment unit 106 assess the costs for the deliveries by using the result of the simulation performed by the simulation unit 105. By referring to the result of the assessment, the user can determine whether or not distributions will be able to be efficiently performed after the distribution hub is set up at the distribution hub candidate site.

The simulation unit 105 can perform a simulation for each of a plurality of patterns in which places where the distribution hubs are set up, the number of distribution hubs, and the scales thereof differ from one another. In that case, the user can compare the results of assessments with one another, and thereby find out the pattern according to which the distribution hub should set up so that the costs for the deliveries is minimized. Therefore, the user can select, without relying on his/her experience and intuition, the place where the distribution hub is set up so that deliveries can be efficiently performed.

Note that although an example in which the candidate site determination unit 104, the simulation unit 105, and the assessment unit 106 are included in the distribution analysis apparatus 100 has been described in the above-described example embodiment, the present disclosure is not limited to such an example. The candidate site determination unit 104, the simulation unit 105, and the assessment unit 106 may be constructed as a separate apparatus(es) (a distribution hub setting-up support apparatus) different from the distribution analysis apparatus 100. In that case, the distribution hub setting-up support apparatus does not necessarily have to be used together with the distribution analysis apparatus 100, and may be used alone.

Although an example in which the loading information collected by the loading information collecting unit 101 is used in the loading rate summarizing unit 102 and the simulation unit 105 has been described in the above-described example embodiment, the present disclosure is not limited to such an example. The loading rate summarizing unit 102 and the simulation unit 105 does not necessarily have to use the same loading information. In other words, the loading information that the loading rate summarizing unit 102 uses to summarize the package loading rate and the loading information that the simulation unit 105 uses in the simulation may be different from each other.

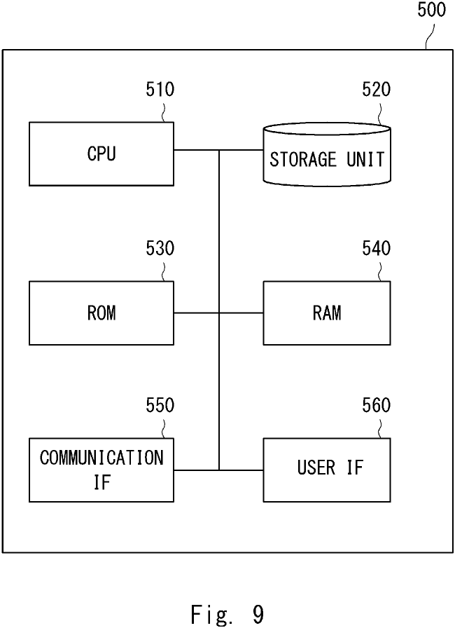

In the present disclosure, the distribution analysis apparatus 100 may be constructed by using a computer apparatus (a server apparatus). FIG. 9 shows an example of a configuration of a computer apparatus that can be used for the distribution analysis apparatus 100. The computer apparatus 500 includes a control unit (CPU: Central Processing Unit) 510, a storage unit 520, a ROM (Read Only Memory) 530, a RAM (Random Access Memory) 540, a communication interface (IF: Interface) 550, and a user interface 560.

The communication interface 550 is an interface for connecting the computer apparatus 500 to a communication network through wired communication means, wireless communication means, or the like. The user interface 560 includes, for example, a display unit such as a display. Further, the user interface 560 includes an input unit such as a keyboard, a mouse, and a touch panel.

The storage unit 520 is an auxiliary storage device that can hold various types of data. The storage unit 520 does not necessarily have to be a part of the computer apparatus 500, but may be an external storage device, or a cloud storage connected to the computer apparatus 500 through a network.

The ROM 530 is a non-volatile storage device. For example, a semiconductor storage device such as a flash memory having a relatively small capacity can be used for the ROM 530. A program(s) that is executed by the CPU 510 may be stored in the storage unit 520 or the ROM 530. The storage unit 520 or the ROM 530 stores, for example, various programs for implementing the function of each unit in the distribution analysis apparatus 100.

The aforementioned program can be stored and provided to the computer apparatus 500 by using any type of non-transitory computer readable media. Non-transitory computer readable media include any type of tangible storage media. Examples of non-transitory computer readable media include magnetic storage media such as floppy disks, magnetic tapes, and hard disk drives, optical magnetic storage media such as magneto-optical disks, optical disk media such as CD (Compact Disc) and DVD (Digital Versatile Disk), and semiconductor memories such as mask ROM, PROM (Programmable ROM), EPROM (Erasable PROM), flash ROM, and RAM. Further, the program may be provided to a computer using any type of transitory computer readable media. Examples of transitory computer readable media include electric signals, optical signals, and electromagnetic waves. Transitory computer readable media can provide the program to a computer via a wired communication line such as electric wires and optical fibers or a radio communication line.

The RAM 540 is a volatile storage device. As the RAM 540, various types of semiconductor memory apparatuses such as a DRAM (Dynamic Random Access Memory) or an SRAM (Static Random Access Memory) can be used. The RAM 540 can be used as an internal buffer for temporarily storing data and the like. The CPU 510 expands (i.e., loads) a program stored in the storage unit 520 or the ROM 530 in the RAM 540, and executes the expanded (i.e., loaded) program. The function of each unit in the distribution analysis apparatus 100 can be implemented by having the CPU 510 execute a program. The CPU 510 may include an internal buffer in which data and the like can be temporarily stored.

Although example embodiments according to the present disclosure have been described above in detail, the present disclosure is not limited to the above-described example embodiments, and the present disclosure also includes those that are obtained by making changes or modifications to the above-described example embodiments without departing from the scope of the present disclosure.

The whole or part of the example embodiments disclosed above can be described as, but not limited to, the following Supplementary notes.

### Supplementary Note 1

A distribution analysis apparatus comprising:
loading information collecting means for collecting loading information of a vehicle configured to deliver packages;
loading rate summarizing means for summarizing a package loading rate for each vehicle for each predetermined summarizing unit based on the loading information collected within a predetermined period; and
display means for displaying the summarized package loading rate on a map.

### Supplementary Note 2

The distribution analysis apparatus described in Supplementary note 1, wherein the loading rate summarizing means summarizes the package loading rate for each vehicle for each route on which the vehicle travels.

### Supplementary Note 3

The distribution analysis apparatus described in Supplementary note 2, wherein the loading rate summarizing means summarizes the package loading rate for each vehicle for each direction in the route.

### Supplementary Note 4

The distribution analysis apparatus described in any one of Supplementary notes 1 to 3, wherein the loading rate summarizing means summarizes the package loading rate for each vehicle for each unit distance.

### Supplementary Note 5

The distribution analysis apparatus described in any one of Supplementary notes 1 to 4, wherein the loading rate summarizing means summarizes the package loading rate for each vehicle for each type of packages.

### Supplementary Note 6

The distribution analysis apparatus described in any one of Supplementary notes 1 to 5, wherein the loading information includes information indicating an amount of packages loaded in the vehicle, and the package loading rate is expressed as a ratio of the amount of packages to a maximum loading capacity of the vehicle.

### Supplementary Note 7

The distribution analysis apparatus described in any one of Supplementary notes 1 to 6, wherein the display means displays the summarized loading rate on a geographic information system (GIS: Geographic Information System) map or a map schematically showing travelling route of the vehicle.

### Supplementary Note 8

The distribution analysis apparatus described in any one of Supplementary notes 1 to 7, further comprising:
candidate site determination means for determining at least one candidate site for a distribution hub;
simulation means for performing a simulation by using the collected loading information, and thereby simulating deliveries of the packages under an assumption that the distribution hub has been set up at the candidate site; and
assessment means for assessing, by using a result of the simulation performed by the simulation means, a cost for the deliveries under the assumption that the distribution hub has been set up at the candidate site.

### Supplementary Note 9

The distribution analysis apparatus described in Supplementary note 8, wherein the simulation means determines whether or not the candidate site of the distribution hub is included in the delivery route of the vehicle, and when the candidate site of the distribution hub is included in the delivery route of the vehicle, performs the simulation under an assumption that the vehicle temporarily stores the packages to be delivered in the distribution hub.

### Supplementary Note 10

The distribution analysis apparatus described in Supplementary note 9, wherein the simulation means performs the simulation under an assumption that packages, which have been temporarily stored in the distribution hub, are loaded on vehicles and then the vehicles deliver them from the distribution hub to a next delivery point.

### Supplementary Note 11

The distribution analysis apparatus described in any one of Supplementary notes 8 to 10, wherein
the distribution hub includes a plurality of different-scale distribution hubs of which amounts of packages that can be temporarily stored are different from each other, and
the candidate site determination means determines a candidate site for the distribution hub from among a plurality of candidate sites under a constraint condition, and determines a scale of the distribution hub.

### Supplementary Note 12

The distribution analysis apparatus described in Supplementary note 11, wherein
a setting-up budget is determined for each of the plurality of different-scale distribution hubs, and the constraint condition includes an upper limit for the number of distribution hubs to be set up and an upper limit for a setting-up budget for the distribution hubs, and
the candidate site determination means determines a combination of the number of distribution hubs to be set up and the scales of the distribution hubs so that the number of distribution hubs is equal to or less than the upper limit therefor and a sum total of the setting-up budgets for the distribution hubs is equal to or lower than the upper limit therefor.

### Supplementary Note 13

The distribution analysis apparatus described in any one of Supplementary notes 8 to 12, wherein the assessment means calculates, as an index indicating the cost for the deliveries, at least one of a sum total of traveling distances of vehicles, a sum total of values that are obtained by multiplexing traveling distances of vehicles by amounts of packages delivered by respective vehicles, or a sum total of setting-up budgets for the distribution hub.

### Supplementary Note 14

A distribution hub setting-up support apparatus comprising:
candidate site determination means for determining at least one candidate site for a distribution hub;
simulation means for performing a simulation by using loading information of a vehicle configured to deliver packages, and thereby simulating deliveries of the packages under an assumption that the distribution hub has been set up at the candidate site; and
assessment means for assessing, by using a result of the simulation performed by the simulation means, a cost of the deliveries under the assumption that the distribution hub has been set up at the candidate site.

### Supplementary Note 15

The distribution hub setting-up support apparatus described in Supplementary note 14, wherein the simulation means determines whether or not the candidate site of the distribution hub is included in the delivery route of the vehicle, and when the candidate site of the distribution hub is included in the delivery route of the vehicle, performs the simulation under an assumption that the vehicle temporarily stores the packages to be delivered in the distribution hub.

### Supplementary Note 16

The distribution hub setting-up support apparatus described in Supplementary note 15, wherein the simulation means performs the simulation under an assumption that packages, which have been temporarily stored in the distribution hub, are loaded on vehicles and then the vehicles deliver them from the distribution hub to a next delivery point.

### Supplementary Note 17

The distribution hub setting-up support apparatus described in any one of Supplementary notes 14 to 16, wherein
the distribution hub includes a plurality of different-scale distribution hubs of which the amounts of packages that can be temporarily stored are different from each other, and
the candidate site determination means determines a candidate site for the distribution hub from among a plurality of candidate sites under a constraint condition, and determines a scale of the distribution hub.

### Supplementary Note 18

The distribution hub setting-up support apparatus described in Supplementary note 17, wherein
a setting-up budget is determined for each of the plurality of different-scale distribution hubs, and the constraint condition includes an upper limit for the number of distribution hubs to be set up and an upper limit for a setting-up budget for the distribution hubs, and
a combination of the number of distribution hubs to be set up and the scales of the distribution hubs is determined so that the number of distribution hubs is equal to or less than the upper limit therefor and a sum total of the setting-up budgets for the distribution hubs is equal to or lower than the upper limit therefor.

### Supplementary Note 19

The distribution hub setting-up support apparatus described in any one of Supplementary notes 14 to 18, wherein the assessment means calculates, as an index indicating the cost for the deliveries, at least one of a sum total of traveling distances of vehicles, a sum total of values that are obtained by multiplexing traveling distances of vehicles by amounts of packages delivered by respective vehicles, or a sum total of setting-up budgets for the distribution hub.

### Supplementary Note 20

The distribution analysis method comprising:
collecting loading information of a vehicle configured to deliver packages;
summarizing a package loading rate for each vehicle for each predetermined summarizing unit based on the loading information collected within a predetermined period; and
displaying the summarized package loading rate on a map.

### Supplementary Note 21

A distribution hub setting-up support method comprising:
determining at least one candidate site for a distribution hub;
performing a simulation by using loading information of a vehicle configured to deliver packages, and thereby simulating deliveries of the packages under an assumption that the distribution hub has been set up at the candidate site; and
assessing, by using a result of the simulation, a cost of the deliveries under the assumption that the distribution hub has been set up at the candidate site.

### Supplementary Note 22

A computer readable medium storing a program for causing a computer to perform:
collecting loading information of a vehicle configured to deliver packages;
summarizing a package loading rate for each vehicle for each predetermined summarizing unit based on the loading information collected within a predetermined period; and
displaying the summarized package loading rate on a map.

### Supplementary Note 23

A computer readable medium storing a program for causing a computer to perform:
determining at least one candidate site for a distribution hub;
performing a simulation by using loading information of a vehicle configured to deliver packages, and thereby simulating deliveries of the packages and the like under an assumption that the distribution hub has been set up at the candidate site; and
assessing, by using a result of the simulation, a cost of the deliveries under the assumption that the distribution hub has been set up at the candidate site.

### REFERENCE SIGNS LIST

| | |
|---|---|
| 10 | distribution analysis apparatus |
| 11 | loading information collecting means |
| 12 | loading rate summarizing means |
| 13 | display means |
| 20 | distribution hub setting-up support apparatus |
| 21 | candidate site determination means |
| 22 | simulation means |
| 23 | assessment means |
| 30 | loading information |
| 100 | distribution analysis apparatus |
| 101 | loading information collecting unit |
| 102 | loading rate summarizing unit |
| 103 | display unit |
| 104 | candidate site determination unit |
| 105 | simulation unit |
| 106 | assessment unit |

What is claimed is:

1] A distribution analysis apparatus comprising:
a memory storing instructions, and
a processor configured to execute the instructions to:
collect loading information of a vehicle configured to deliver packages;
summarize a package loading rate for each vehicle for each predetermined summarizing unit based on the loading information collected within a predetermined period; and
display, on a display device, the summarized package loading rate on a map.

2] The distribution analysis apparatus according to claim 1, wherein the processor is configured to execute the instructions to summarize the package loading rate for each vehicle for each route on which the vehicle travels.

3] The distribution analysis apparatus according to claim 2, wherein the processor is configured to execute the instructions to summarize the package loading rate for each vehicle for each direction in the route.

4] The distribution analysis apparatus according to claim 1,wherein the processor is configured to execute the instructions to summarize the package loading rate for each vehicle for each unit distance.

5] The distribution analysis apparatus according to claim 1,wherein the processor is configured to execute the instructions to summarize the package loading rate for each vehicle for each type of packages.

6] The distribution analysis apparatus according to claim 1,wherein the loading information includes information indicating an amount of packages loaded in the vehicle, and the package loading rate is expressed as a ratio of the amount of packages to a maximum loading capacity of the vehicle.

7] The distribution analysis apparatus according to claim 1, wherein the processor is configured to execute the instructions to display the summarized loading rate on a geographic information system (GIS: Geographic Information System) map or a map schematically showing travelling route of the vehicle.

8] The distribution analysis apparatus according to claim 1,the processor is further configured to execute the instructions to:
determine at least one candidate site for a distribution hub;
perform a simulation by using the collected loading information, and thereby simulating deliveries of the packages under an assumption that the distribution hub has been set up at the candidate site; and
assess, by using a result of the performed simulation a cost for the deliveries under the assumption that the distribution hub has been set up at the candidate site.

9] The distribution analysis apparatus according to claim 8, wherein the processor is configured to execute the instructions to determine whether or not the candidate site of the distribution hub is included in the delivery route of the vehicle, and when the candidate site of the distribution hub is included in the delivery route of the vehicle, the processor is configured to execute the instructions to perform the simulation under an assumption that the vehicle temporarily stores the packages to be delivered in the distribution hub.

10] The distribution analysis apparatus according to claim 9, wherein the processor is configured to execute the instructions to perform the simulation under an assumption that packages, which have been temporarily stored in the distribution hub, are loaded on vehicles and then the vehicles deliver them from the distribution hub to a next delivery point.

11] The distribution analysis apparatus according to claim 8, wherein
the distribution hub includes a plurality of different-scale distribution hubs of which amounts of packages that can be temporarily stored are different from each other, and
the processor is configured to execute the instructions to determine a candidate site for the distribution hub from among a plurality of candidate sites under a constraint condition, and determines a scale of the distribution hub.

12] The distribution analysis apparatus according to claim 11, wherein
a setting-up budget is determined for each of the plurality of different-scale distribution hubs, and the constraint condition includes an upper limit for the number of distribution hubs to be set up and an upper limit for a setting-up budget for the distribution hubs, and
the processor is configured to execute the instructions to determine cⁱto dotormⁱnatⁱon a combination of the number of distribution hubs to be set up and the scales of the distribution hubs so that the number of distribution hubs is equal to or less than the upper limit therefor and a sum total of the setting-up budgets for the distribution hubs is equal to or lower than the upper limit therefor.

13] The distribution analysis apparatus according to claim 8,wherein the processor is configured to execute the instructions to calculate, as an index indicating the cost for the deliveries, at least one of a sum total of traveling distances of vehicles, a sum total of values that are obtained by multiplexing traveling distances of vehicles by amounts of packages delivered by respective vehicles, or a sum total of setting-up budgets for the distribution hub.

14] A distribution hub setting-up support apparatus comprising:
a memory storing instructions, and
a processor configured to execute the instructions to:
determine at least one candidate site for a distribution hub;
perform a simulation by using loading information of a vehicle configured to deliver packages, and thereby simulating deliveries of the packages under an assumption that the distribution hub has been set up at the candidate site; and
assess, by using a result of the performed simulation, a cost of the deliveries under the assumption that the distribution hub has been set up at the candidate site.

15] The distribution hub setting-up support apparatus according to claim 14, wherein the processor is configured to execute the instructions to determine whether or not the candidate site of the distribution hub is included in the delivery route of the vehicle, and when the candidate site of the distribution hub is included in the delivery route of the vehicle, performs the simulation under an assumption that the vehicle temporarily stores the packages to be delivered in the distribution hub.

16] The distribution hub setting-up support apparatus according to claim 15, wherein the processor is configured to execute the instructions to perform the simulation under an assumption that packages, which have been temporarily stored in the distribution hub, are loaded on vehicles and then the vehicles deliver them from the distribution hub to a next delivery point.

17] The distribution hub setting-up support apparatus according to claim 14,wherein the distribution hub includes a plurality of different-scale distribution hubs of which the amounts of packages that can be temporarily stored are different from each other, and
the processor is configured to execute the instructions to determine a candidate site for the distribution hub from among a plurality of candidate sites under a constraint condition, and determines a scale of the distribution hub.

18] The distribution hub setting-up support apparatus according to claim 17, wherein
a setting-up budget is determined for each of the plurality of different-scale distribution hubs, and the constraint condition includes an upper limit for the number of distribution hubs to be set up and an upper limit for a setting-up budget for the distribution hubs, and
a combination of the number of distribution hubs to be set up and the scales of the distribution hubs is determined so that the number of distribution hubs is equal to or less than the upper limit therefor and a sum total of the setting-up budgets for the distribution hubs is equal to or lower than the upper limit therefor.

19] The distribution hub setting-up support apparatus according to claim 14,wherein the processor is configured to execute the instructions to calculate, as an index indicating the cost for the deliveries, at least one of a sum total of traveling distances of vehicles, a sum total of values that are obtained by multiplexing traveling distances of vehicles by amounts of packages delivered by respective vehicles, or a sum total of setting-up budgets for the distribution hub.

20. The distribution analysis method comprising:
collecting loading information of a vehicle configured to deliver packages;
summarizing a package loading rate for each vehicle for each predetermined summarizing unit based on the loading information collected within a predetermined period; and
displaying the summarized package loading rate on a map.

21-23. (canceled)
